(19) United States
(12) Patent Application Publication
(10) Pub. No.: US 2025/0018539 A1
(43) Pub. Date: Jan. 16, 2025

(54) CLAMPING DEVICE AND METHOD FOR DETERMINING CURVE OF STROKE CURVE PROTRUSION IN CLAMPING DEVICE

(71) Applicant: Autel Intelligent Technology Corp., Ltd., Shenzhen (CN)

(72) Inventors: Mingyue ZHAO, Shenzhen (CN); Dengguo ZHANG, Shenzhen (CN)

(73) Assignee: Autel Intelligent Technology Corp., Ltd., Shenzhen, GD (CN)

(21) Appl. No.: 18/900,627

(22) Filed: Sep. 27, 2024

Related U.S. Application Data
(63) Continuation of application No. PCT/CN2023/073811, filed on Jan. 30, 2023.

(30) Foreign Application Priority Data
Mar. 28, 2022 (CN) 202210313612.0

(51) Int. Cl. B25B 11/00

(52) U.S. Cl. CPC B25B 11/00

(57) ABSTRACT

A clamping device is provided by embodiments of the present disclosure. The clamping device includes: a rotating assembly including a rotating plate and a connecting rod, where the connecting rod is rotatably connected to a clamping assembly and the rotating plate, respectively, and the rotating plate is provided with a stroke curve protrusion; and an engagement assembly including a ratchet wheel and a ratchet component, where the ratchet component always abuts against the stroke curve protrusion so as to adjust an engagement position of the ratchet component and the ratchet wheel.

### CROSS-REFERENCE TO RELATED APPLICATIONS

This application is a National Stage Application of International Patent Application PCT/CN2023/073811 filed on Jan. 30, 2023, which claims priority to Chinese Patent Application No. 202210313612.0 filed on Mar. 28, 2022, the entire disclosures of which are incorporated herein by reference for all purposes.

### TECHNICAL FIELD

The present disclosure relates to the technical field of vehicle equipment, and in particular to a clamping device, and a method for determining a curve of a stroke curve protrusion in a clamping device.

### BACKGROUND

With the development of automobile industry and the improvement of people's living standards, more and more families own private cars. It is necessary to detect the steering of the wheels after the automobiles are produced, and after a period of use, there might be deviations for the steering of the automobiles, for either situation of which, four-wheel alignment is involved. Through the calibration plate and calibration equipment, the four-wheel parameters of the automobile are collected and adjusted to ensure that the automobile maintains good driving performance and improve the reliability thereof.

At present, as for a tire clamp used in the four-wheel alignment process, due to the use of rotation transmission of connecting rod, the length of each extension of clamping arm is inconsistent, resulting in different forces to hold the tire at different positions, thereby affecting the effectiveness of the alignment.

### SUMMARY

The technical problem to be mainly solved by the embodiments of the present disclosure is to provide a clamping device and a method for determining a curve of a stroke curve protrusion in the clamping device, so that a retraction length of the clamping assembly is consistent regardless of where the clamping assembly clamps the tire, thereby making the clamping device clamps an object to be clamped with consistent force.

Some embodiments of the present disclosure provide a clamping device including a mounting base, a clamping assembly, a rotating assembly, a first drive assembly and an engagement assembly, a clamping assembly including at least two clamping components, where the at least two clamping components are both provided on the mounting base, and are movable relative to the mounting base; the rotating assembly includes a rotating plate and at least two connecting rods, the rotating plate is rotatably provided on the mounting base, first ends of the at least two connecting rods are both rotatably connected to one of the rotating plate, a second end of the connecting rod is rotatably connected to one of the clamping components, and the rotating plate is provided with a stroke curve protrusion; a first drive assembly is provided on the mounting base; the engagement assembly includes a ratchet wheel and a ratchet component, where the ratchet wheel is fixed to the rotating plate, the ratchet component can rotate relative to the rotating plate, the first drive assembly is connected to the ratchet component, and when the first drive assembly is driven, the first drive assembly drives the ratchet component to move relative to the rotating assembly, where when the first drive assembly is located at a first position, the ratchet wheel and the ratchet component are disengaged; when the first drive assembly is located at a second position, the ratchet wheel and the ratchet component are engaged; when the first drive assembly is located at an end position, the first drive assembly is locked, and when the first drive assembly moves from a second position to an end position, the ratchet component drives the ratchet wheel to rotate, thereby driving the rotating assembly to rotate; when the rotating plate rotates, the stroke curve protrusion is configured to adjust, when the rotating plate rotates, a distance between the ratchet wheel and the ratchet component, so that when the clamping assembly is at different positions, the second position is different, so that when the first drive assembly moves from the second position to the end position, the rotating plate rotates at different angles, and a moving distance of the clamping assembly at different positions relative to the mounting base remains the same.

Some embodiments of the present disclosure provide a method for determining a curve of a stroke curve protrusion in a clamping device, the method including: determining a first distance required by the clamping assembly when the first drive assembly moves from a second position to an end position; acquiring a length of the connecting rod; acquiring a second distance between a first end of the connecting rod and a rotation center point of the rotating plate and a first included angle between a first connecting line and a second connecting line when the clamping assembly is at each sampling position, where the first connecting line is a connecting line between the second end of the connecting rod and the rotation center point of the rotating plate, and the second line is a connecting line between the first end of the connecting rod and the rotation center point of the rotating plate; calculating a rotation angle required by the rotating plate when the clamping assembly is at each sampling position according to the first distance, the length of the connecting rod, the second distance and the first included angle; and determining the curve of the stroke curve protrusion according to the rotation angle required to rotate the plate when the clamping assembly is in each sampling position.

Some embodiments of the present disclosure provide a device for determining a curve of a stroke curve protrusion of a clamping device, the device including: a first determination part configured to determine a first distance required by the clamping assembly when the first drive assembly moves from a second position to an end position; a first acquisition part configured to acquire a length of the connecting rod; a second acquisition part configured to acquire a second distance between a first end of the connecting rod and a rotation center point of the rotating plate and a first included angle between a first connecting line and a second connecting line when the clamping assembly is at each sampling position, where the first connecting line is a connecting line between the second end of the connecting rod and the rotation center point of the rotating plate, and the second line is a connecting line between the first end of the connecting rod and the rotation center point of the rotating plate; a calculation part configured to calculate a rotation angle required by the rotating plate when the clamping assembly is at each sampling position according to the first distance, the length of the connecting rod, the second distance and the first included angle; and a second determination part configured to determine the curve of the stroke curve protrusion according to the rotation angle required to rotate the plate when the clamping assembly is in each sampling position.

Some embodiments of the present disclosure provide a detection apparatus including: a controller including at least one processor, and a memory communicatively coupled to the at least one processor; where the memory stores instructions executable by the at least one processor, the instructions being executed by the at least one processor to enable the at least one processor to perform the method as described above.

Some embodiments of the present disclosure provide a non-transitory computer-readable storage medium storing computer-executable instructions for causing a server to perform the method as described above.

### BRIEF DESCRIPTION OF DRAWINGS

In order that the detailed description of the present disclosure or the related art may be more clearly understood, a brief description of the drawings that accompany the detailed description of the present disclosure or the prior art is set forth below. Throughout the drawings, same elements or portions are generally identified by same reference numerals. In the drawings, elements or portions may not necessarily be drawn to scale.

FIG. 1 is an exploded view of a clamping device according to an embodiment of the present disclosure;

FIG. 2 is an exploded view of a mounting base in a clamping device according to an embodiment of the present disclosure;

FIG. 3 is an exploded view of a rotating assembly in a clamping device according to an embodiment of the present disclosure;

FIG. 4 is an exploded view of an engagement assembly in a clamping device according to an embodiment of the present disclosure;

FIG. 5 is a schematic view of a first drive assembly in a clamping device according to an embodiment of the present disclosure;

FIG. 6 is a schematic view of a first drive assembly in a clamping device from another perspective according to an embodiment of the present disclosure;

FIG. 7 is an exploded view of a fourth connector in a clamping device according to an embodiment of the present disclosure;

FIG. 8 is an exploded view of a clamping assembly in a clamping device according to an embodiment of the present disclosure;

FIG. 9 is a schematic view of a sliding sleeve and a sleeve rod in a clamping device according to an embodiment of the present disclosure;

FIG. 10 is a cross-sectional view of a first locking assembly in a clamping device according to an embodiment of the present disclosure;

FIG. 11 is an exploded view of a runner module in a clamping device according to an embodiment of the present disclosure;

FIG. 12 is an enlarged view of a limiting module in a clamping device according to an embodiment of the present disclosure;

FIG. 13 is an exploded view from a perspective of a second drive module in a clamping device according to an embodiment of the present disclosure;

FIG. 14 is a schematic diagram of an application environment of a method for determining a curve of a stroke curve protrusion of a clamping device according to another embodiment of the present disclosure;

FIG. 15 is a flow chart of a method for determining a curve of a stroke curve protrusion of a clamping device according to another embodiment of the present disclosure;

FIG. 16 is a flowchart of step S105 in the method for determining the curve of the stroke curve protrusion of the clamping device according to another embodiment of the present disclosure;

FIG. 17 is a structural block diagram of a device for determining a curve on which a stroke curve protrusion of a clamping device is located according to another embodiment of the present disclosure; and

FIG. 18 is a schematic diagram of a computing apparatus according to yet another embodiment of the present disclosure.

### DETAILED DESCRIPTION

To facilitate an understanding of the present disclosure, a more particular description of the present disclosure will be rendered by reference to specific embodiments thereof which are illustrated in the appended drawings. It will be understood that when an element is referred to as being “fixed to” to another element, it may be directly on the other element or indirectly on the other element through one or more intervening elements. When an element is referred to as being “connected” to another element, it may be directly connected to the other element or indirectly connected to the other element through one or more intervening elements. As used in the description, the terms “upper,” “lower,” “inner,” “outer,” “vertical,” “horizontal,” and the like indicate orientations or positional relationships based on the orientation or positional relationships shown in the drawings, are merely for convenience in describing and simplifying the present disclosure, and do not indicate or imply that the referenced devices or elements must have a particular orientation, be constructed and operated in a particular orientation, and thus are not to be construed as limiting the present disclosure. Further, the terms “first”, “second”, etc. are used for descriptive purposes only and are not to be construed as indicating or implying relative importance.

Unless defined otherwise, all technical and scientific terms used in the specification have the same meaning as commonly understood by a person skilled in the art to which the present disclosure belongs. The terminology used in the description of the present disclosure is used for the purpose of describing particular embodiments only and is not intended to be limiting of the present disclosure. As used herein, the term “and/or” includes any and all combinations of one or more of the associated listed items.

Further, the technical features involved in the different embodiments of the present disclosure described below can be combined with each other as long as they do not conflict with each other.

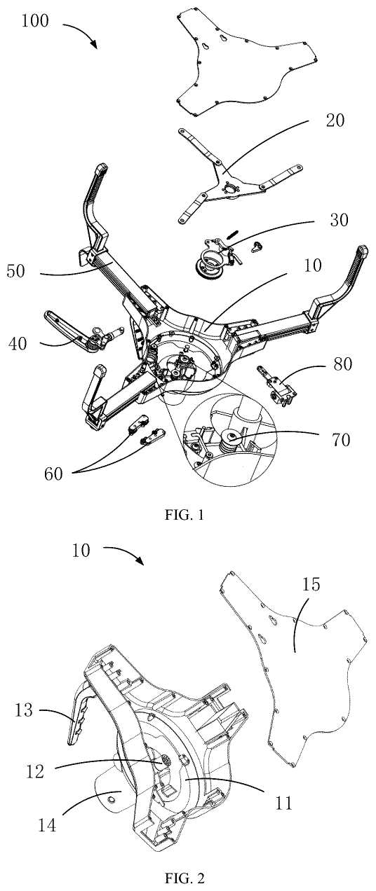

Referring to FIG. 1, provided is a clamping device 100, including a mounting base 10, a rotating assembly 20, an engagement assembly 30, a first drive assembly 40, a clamping assembly 50, a runner assembly 60, a second drive assembly 80, and a limiting assembly 70. The rotating assembly 20, the engagement assembly 30, the first drive assembly 40, the clamping assembly 50, the runner assembly 60, the second drive assembly 80 and the limiting assembly 70 are all provided on the mounting base 10. The first drive assembly 40 is connected to the rotating assembly 20, and the rotating assembly 20 is connected to the clamping assembly 50, the second drive assembly 80 is connected to the clamping assembly 50 and used for driving the clamping assembly 50 to move away from each other relative to the mounting base 10 so that the clamping device 100 is in a state to be using for clamping, the first drive assembly 40 is used for driving the engagement assembly 30 to rotate, and when the first drive assembly 40 is in a second position and the engagement assembly 30 is in an engagement state, the rotating assembly 20 can rotate synchronously with the engagement assembly 30; the rotating assembly 20 moves the clamping assembly 50 towards each other relative to the mounting base 10, so that the clamping device 100 clamps an object to be clamped. The runner assembly 60 is connected to the clamping assembly 50, and the runner assembly 60 is used for supporting the clamping assembly 50 and guiding the movement of the clamping assembly 50. The limiting assembly 70 serves to limit the rotation angle range of the rotating assembly 20 to prevent a rotation dead zone of the rotating assembly 20.

Referring to FIG. 2, the mounting base 10 is provided with an accommodating space 11, a rotating shaft 12, a grip 13, a mounting portion 14, and a cover plate 15. The accommodating space 11 is used for accommodating the rotating assembly 20, the engagement assembly 30, the first drive assembly 40, the clamping assembly 50, the runner assembly 60, the second drive assembly 80 and the limiting assembly 70, where a rotating shaft 12 is provided at the center of the accommodating space 11, the rotating shaft 12 is used for passing the rotating assembly 20 and the engagement assembly 30 therethrough, both the rotating assembly 20 and the engagement assembly 30 may rotate around the rotating shaft 12, and when the engagement assembly 30 is in an engaged state, the engagement assembly 30 rotates synchronously with the rotating assembly, and when the engagement assembly 30 is in a non-engaged state, the engagement assembly 30 may rotate relative to the rotating assembly 20. A grip 13 is provided on a surface of the mounting base 10 facing away from the accommodating space 11 and is adapted to be gripped by a user to facilitate use and handling of the clamping device 100. A mounting portion 14 is provided on a surface of the mounting base 10 facing away from the accommodating space 11 and is used for mounting a calibration assembly. In some embodiments, the calibration assembly includes a calibration plate. The cover plate 15 is used for covering the accommodating space 11 and preventing the rotating assembly 20, the engagement assembly 30, the first drive assembly 40, the clamping assembly 50, the runner assembly 60, the second drive assembly 80 and the limiting assembly 70 in the accommodating space 11 from being exposed, to enhance the aesthetic appearance of the mounting base 10, and at the same time, the cover plate 15 is used for preventing impurities from entering the accommodating space 11 and interfering with the normal operation of the clamping device 100.

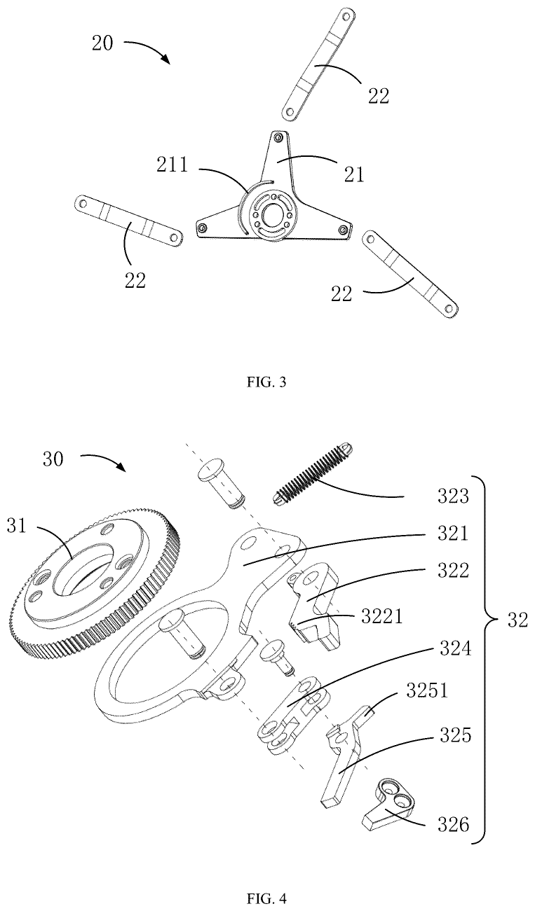

Regarding the above-mentioned rotating assembly 20, referring to FIG. 3, the rotating assembly 20 includes a rotating plate 21 and at least two connecting rods 22, where a first end of the connecting rod 22 is rotatably connected to the rotating plate 21, and a second end of the connecting rod 22 is rotatably connected to the clamping assembly 50. The rotating plate 21 is provided with a stroke curve protrusion 211 for cooperating with the engagement assembly 30 to control the state of the engagement assembly 30.

With respect to the engagement assembly 30 described above, referring to FIG. 4, the engagement assembly 30 includes a ratchet wheel 31 and a ratchet component 32. The ratchet wheel 31 is rotatably provided to the rotating shaft 12 and fixedly connected to the rotating plate 21, and the ratchet component 32 includes a rotating portion 321, a detent 322, a first clastic member 323, a first connector 324, a ratchet stop 325, and a limiting member 326. The rotating portion 321 is rotatably provided to the rotating shaft 12, and is rotatable relative to the rotating plate 21 and the ratchet wheel 31. A first end of the detent 322 is rotatably provided on the rotating portion 321, a second end of the detent 322 is provided with a ratchet 3221 for engaging with the ratchet wheel 31, a first end of the first connector 324 is rotatably connected to the rotating portion 321, a second end of the first connector 324 is rotatably connected to a first end of the ratchet stop 325, the first end of the ratchet stop 325 is provided with a first protrusion 3251, the first protrusion 3251 abuts against the second end of the detent 322, the first end of the ratchet stop 325 always abuts against the stroke curve protrusion 211, the limiting member 326 is fixed on the mounting base 10, and the second end of the ratchet stop 325 always abuts against the limiting member 326. One end of a first elastic member 323 is provided to the mounting base 10, and the other end of the first elastic member 323 is connected to the first end of the detent 322, and the first elastic member 323 is used to move the second end of the detent 322 in a direction close to the ratchet wheel 31.

In some embodiments, a junction of the first connector 324 with the rotating portion 321 and a junction of the first connector 324 with the ratchet stop 325 are each provided with a spring such that when the rotating portion 321 rotates, a first end of the ratchet stop 325 always abuts against the stroke curve protrusion 211 and a second end of the ratchet stop 325 always abuts against the limiting member 326.

In some embodiments, the engagement assembly 30 includes a friction ratchet wheel 31 provided to the rotating shaft 12, the friction ratchet wheel 31 being fixedly connected to the rotating plate 21, and an eccentric sector wedge rotatably provided to the rotating portion 321, the eccentric sector wedge being for engagement with the friction ratchet wheel 31.

With respect to the first drive assembly 40 described above, referring to FIG. 5, the first drive assembly 40 includes a handle 41, a second connector 42, a third connector 43, and a fourth connector 44. A first end of the handle 41 is provided with a second protrusion 411, the second protrusion 411 is rotatably provided on the mounting base 10, the handle 41 is located on a side of the mounting base 10 facing away from the accommodating space 11, a second connector 42, a third connector 43 and a fourth connector 44 are all provided in the accommodating space 11, a first end of the second connector 42 is rotatably connected to the second protrusion 411 of the handle 41, a first end of the third connector 43 is rotatably connected to the mounting base 10, a second end of the second connector 42 and a second end of the third connector 43 are rotatably connected to a first end of the fourth connector 44, and a second end of the fourth connector 44 is rotatably connected to the rotating portion 321.

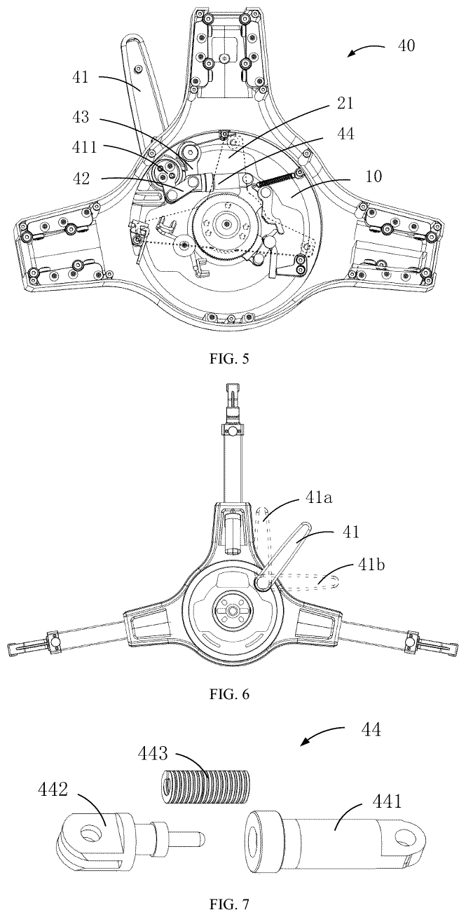

Referring to FIG. 6, the handle 41 is provided with a start position 41a and an end position 41b, and the direction in which the handle 41 is rotated from the start position 41a to the end position 41b is defined as a first direction, and the direction in which the handle 41 is rotated from the end position 41b to the start position 41a is defined as a second direction. The handle 41 is further provided with a first position (not shown) and a second position (not shown), where the first position is a position where the handle 41 is located when the ratchet 3221 and the ratchet wheel 31 change from an engaged state to a disengaged state; the second position is the position where the handle 41 is located when the ratchet 3221 and ratchet wheel 31 transit from the disengaged state to the engaged state, the second position being different when the clamping assembly 50 is in a different position relative to the mounting base 10.

In an embodiment, referring to FIGS. 4 to 6, when an external force is applied to the handle 41 so that the handle 41 rotates in a first direction, the second protrusion 411 pushes the second connector 42 to move, the third connector 43 rotates in the first direction relative to the mounting base 10, the fourth connector 44 pushes the rotating portion 321 to rotate in a second direction, and the rotating portion 321 drives the detent 322, the first connector 324 and the ratchet stop 325 to rotate relative to the ratchet wheel 31 and the rotating plate 21, under a force of the first elastic member 323. The second end of the detent 322 moves in a direction close to the ratchet wheel 31; under the action of the first connector 324, the first end of the ratchet stop 325 slides along the stroke curve protrusion 211 and always abuts against the stroke curve protrusion 211; the ratchet stop 325 rotates relative to the first connector 324 in a first direction; in this process, the engagement assembly 30 is in a non-engagement state, i.e., the ratchet component 32, the ratchet wheel 31 and the rotating plate 21 may rotate relative to each other until the handle 41 moves to the second position; the ratchet 3221 at the second end of the detent 322 is engaged with the ratchet wheel 31; at this moment, the engagement assembly 30 is in an engaged state, i.e., the ratchet component 32 and the ratchet wheel 31 and the rotating plate 21 may rotate synchronously; the handle 41 continues to move in the first direction (the handle 41 moves from the second position to the direction of the end position 41b); the detent 322 drives the ratchet wheel 31 and the rotating plate 21 to rotate; the rotating plate 21 drives the clamping assembly 50 to move relative to the mounting base 10 in the direction towards the accommodating space 11; and when the third connector 43 and the fourth connector 44 are co-linear, with the handle 41 in the end position 41b, the third connector 43 and the fourth connector 44 are in a self-locked state, the rotating portion 321 is locked to the mounting base 10.

When an external force is applied to the handle 41 so that the handle 41 rotates in a second direction, the second protrusion 411 pulls the second connector 42 to move; the second connector 42 pulls the third connector 43 and the fourth connector 44 to move so that the third connector 43 and the fourth connector 44 are not co-linear; the third connector 43 and the fourth connector 44 are in an unlocked state; the fourth connector 44 pulls the rotating portion 321 to rotate in the first direction; the second protrusion 411 of the first end of the ratchet stop 325 lifts the second end of the detent 322 in a direction away from the ratchet wheel 31; when the handle 41 is in the first position, the ratchets 3221 disengage from the ratchet wheel 31, and at this time, the engagement assembly 30 is in an unengaged state, and the ratchet component 32 may rotate relative to the ratchet wheel 31 and the rotating plate 21 to apply an external force to the clamping assembly 50, so that the clamping assembly 50 moves away relative to the mounting base 10, and the object to be clamped is released from the clamping device 100.

Regarding the above-mentioned fourth connector 44, referring to FIG. 7, the fourth connector 44 includes a compression outer cylinder 441, a compression rod 442 and a second clastic member 443, where a first end of the compression rod 442 is rotatably connected to a second end of the second connector 42 and a second end of the third connector 43, a second end of the compression rod 442 is sleeved with the compression outer cylinder 441, the compression outer cylinder 441 is rotatably connected to the rotating portion 321, the second clastic member 443 is provided inside the compression outer cylinder 441, and two ends of the second elastic member 443 respectively abut against the compression rod 442 and the compression outer cylinder 441, the compression rod 442 is telescopically movable within the compression outer cylinder 441, and the second elastic member 443 serves to cushion the movement between the compression rod 442 and the compression outer cylinder 441.

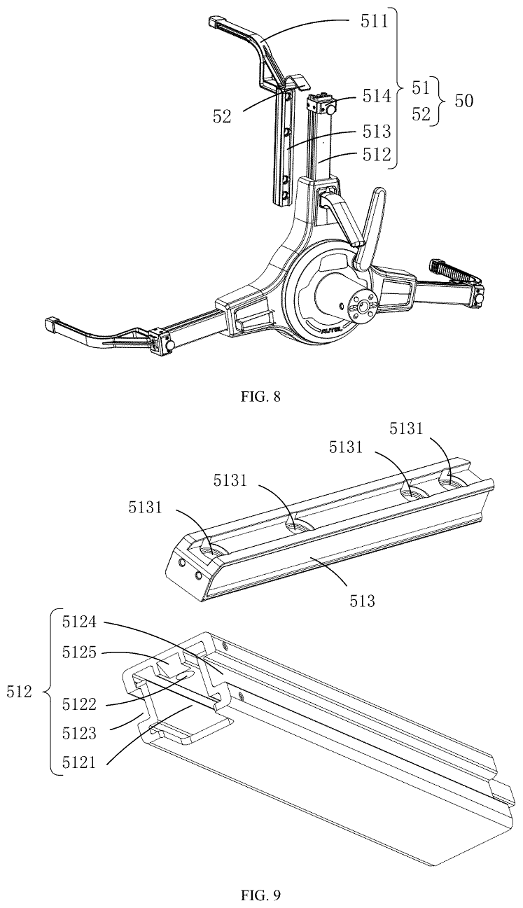

Regarding the above-mentioned clamping assembly 50, referring to FIG. 8, the clamping assembly 50 includes a pull hook 52 and at least two clamping components 51, where a first end of the clamping assembly 51 is rotatably connected to a second end of the connecting rod 22, and the second end of the clamping assembly 51 extends from the accommodating space 11 to the accommodating space 11; the at least two clamping components 51 may slide relative to the mounting base 10; when the clamping components 51 slide towards each other, the clamping device 100 is in a clamping state, and the clamping components 51 may clamp an object to be clamped; and when the clamping components 51 slide away from each other, the clamping device 100 is in a state to be used for clamping, and the clamping components 51 release an object to be clamped. A pull hook 52 is provided at the second end of the clamping assembly 51, and the pull hook 52 is used for a user to drive the clamping assembly 51 to move apart so that the clamping device 100 is in a state to be used for clamping.

In some embodiments, the number of clamping components 51 is three, the three clamping components 51 are uniformly provided on the mounting base 10, the three clamping components 51 are all rotatably connected to the rotating assembly 20, and the three clamping components 51 is movable synchronously to make the clamping effect of the clamping device 100 better.

The clamping assembly 51 includes a jaw 511, a sliding sleeve 512, a sleeve rod 513, and a first locking assembly 514. A first end of the sliding sleeve 512 is rotatably connected to a second end of the connecting rod 22, the second end of the sliding sleeve 512 extends out of the accommodating space 11 from the accommodating space 11, two sides of the sliding sleeve 512 are respectively connected to the runner assembly 60, the sliding sleeve 512 may reciprocally and telescopically slide relative to the mounting base 10, the sleeve rod 513 is sleeved in the sliding sleeve 512, and the sleeve rod 513 may telescopically slide relative to the sliding sleeve 512, a jaw 511 is provided at the first end of the sleeve rod 513, and the jaw 511 is used for abutting against and clamping the object to be clamped, the first locking assembly 514 is provided between the sliding sleeve 512 and the sleeve rod 513, the first locking assembly 514 is used for locking or unlocking the sleeve rod 513, and when the first locking assembly 514 is in a locked state, the sliding sleeve 512 and the sleeve rod 513 are relatively fixed, and when the first locking assembly 514 is in an unlocked state, the sleeve rod 513 is allowed to slide relative to the sliding sleeve 512.

Regarding the above-mentioned sliding sleeve 512 and sleeve rod 513, referring to FIG. 9, the sliding sleeve 512 is provided with a telescopic groove 5121, a first through-hole 5122, a first sliding groove 5123, a second sliding groove 5124 and a transition groove 5125. The telescopic groove 5121 extends from the second end of the sliding sleeve 512 to the first end of the sliding sleeve 512, and the telescopic groove 5121 is used for accommodating a sleeve rod 513, and the sleeve rod 513 reciprocally and telescopically moves relative to the sliding sleeve 512 within the telescopic groove 5121. A first through-hole 5122 is provided at one surface of the sliding sleeve 512, and the first through-hole 5122 communicates the telescopic groove 5121 with the outside, the first through-hole 5122 is used for passing the first locking assembly therethrough. The first sliding groove 5123 and the second sliding groove 5124 are respectively provided on two sides of the sliding sleeve 512, the first sliding groove 5123 and the second sliding groove 5124 are both used for abutting against the runner assembly 60, and the first sliding groove 5123 and the second sliding groove 5124 cooperate with the runner assembly 60 so that the sliding sleeve 512 slides back and forth in a unique direction relative to the mounting base 10. A transition groove 5125 is provided at the second end of the sliding sleeve 512, the transition groove 5125 communicates with the telescopic groove 5121 and is used for sliding the first locking assembly 514 so that the sleeve rod 513 may be retracted into the telescopic groove 5121. The sleeve rod 513 is provided with a mounting groove 5131 for mounting the first locking assembly 514.

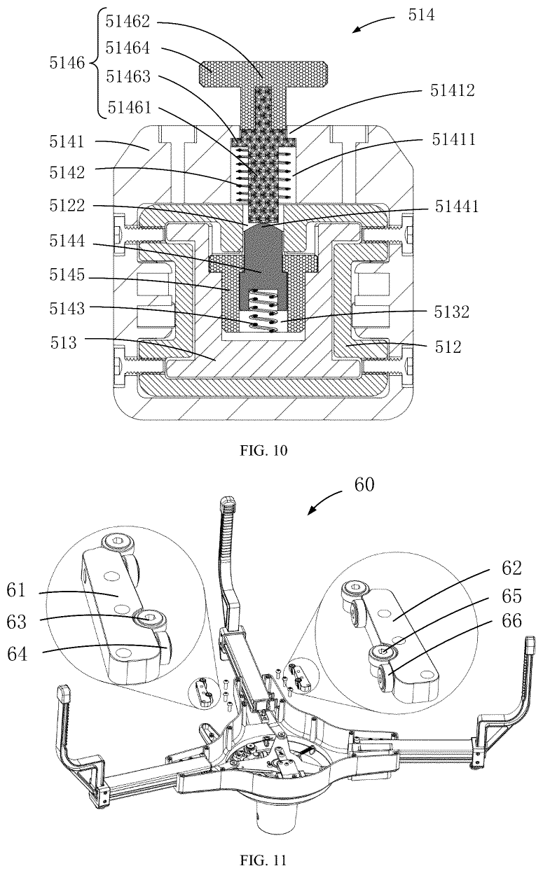

As for the first locking assembly 514 described above, referring to FIG. 10, the first locking assembly 514 includes a locking base 5141, a third clastic member 5142, a fourth clastic member 5143, a thimble 5144, a thimble base 5145, and a button 5146. The locking base 5141 is provided on the sliding sleeve 512, a third elastic member 5142 and a button 5146 are provided on the locking base 5141, and two ends of the third elastic member 5142 respectively abut against the sliding sleeve 512 and the button 5146. The fourth elastic member 5143, the thimble 5144 and the thimble base 5145 are all provided in the mounting groove 5131; the thimble base 5145 and the mounting groove 5131 together enclose a mounting cavity 5132; the thimble 5144 and the fourth elastic member 5143 are provided in the mounting cavity 5132; a first end of the fourth elastic member 5143 is fixed to a groove bottom of the mounting groove 5131; a second end of the fourth clastic member 5143 is fixed to a first end of the thimble 5144; and the second end of the thimble 5144 passes through the thimble base 5145 and is inserted into the first through-hole 5122.

The locking base 5141 is provided with a second through-hole 51411 and a second barrier 51412, where the second through-hole 51411 penetrates the locking base 5141, communicates with the first through-hole 5122 and is used for passing the button 5146 therethrough, the second barrier 51412 is provided at an end of the second through-hole 51411 away from the first through-hole 5122, and the second barrier 51412 is used for blocking the button 5146 from moving in a direction away from the first through-hole 5122 to prevent the button 5146 from being detached from the second through-hole 51411.

The second end of the thimble 5144 is provided with a transition portion 51441 that facilitates the thimble 5144 to exit the first through-hole 5122 when the first locking assembly 514 unlocks the sleeve rod 513. In some embodiments, the transition portion 51441 is hemispherical, or frustoconical, or conical, or pyramidal.

The button 5146 includes a pressing portion 51462 extending outward from a surface of the pressing portion 51462, and an extending portion 51461 inserted into the first through-hole 5122 from the second through-hole 51411 to abut against the transition portion 51441 of the thimble 5144. The side wall of the pressing portion 51462 is provided with a first barrier 51464 for cooperating with a second barrier 51412 to limit the range of movement of the button 5146 in a direction close to the first through-hole 5122, the extending portion 51461 is provided with a third barrier 51463 for cooperating with the second barrier 51412 to limit the range of movement of the button 5146 in a direction away from the first through-hole 5122, the second barrier 51412 is located between the first barrier 51464 and the third barrier 51463, and both ends of the third elastic member 5142 abut against the sliding sleeve 512 and the third barrier 51463, respectively.

In an embodiment, when an external force is applied to the pressing portion 51462, the pressing portion 51462 drives the extending portion 51461 to push the thimble 5144 out of the first through-hole 5122, the thimble 5144 retracts into the mounting cavity 5132, the sleeve rod 513 and the sliding sleeve 512 are in an unlocked state, the sleeve rod 513 may slide back and forth relative to the sliding sleeve 512, the second barrier 51412 blocks the movement of the first barrier 51464, preventing the extending portion 51461 from penetrating out of the first through-hole 5122 and entering the mounting cavity 5132, and hindering the movement of the sleeve rod 513. When the external force is removed, the third clastic member 5142 pushes the extending portion 51461 away from the first through-hole 5122, the second barrier 51412 blocks the movement of the third barrier 51463, prevents the extending portion 51461 from leaving the second through-hole 51411, and the button 5146 is disengaged from the locking base 5141. When the sleeve rod 513 is moved such that the thimble 5144 is again aligned with the first through-hole 5122, the fourth elastic member 5143 pushes the thimble 5144 out of the thimble holder 5145 and into the first through-hole 5122, the first locking assembly 514 is in a locked state, and the sleeve rod 513 and the sliding sleeve 512 are again relatively fixed.

In some embodiments, the third elastic member 5142 and the fourth elastic member 5143 are springs.

In some embodiments, the pressing portion 51462 and the extending portion 51461 of the button 5146 are independent structures, and the pressing portion 51462 and the extending portion 51461 are connected into the second through-hole 51411 from both ends of the second through-hole 51411, respectively.

In some embodiments, the sleeve rod 513 is provided with a plurality of mounting grooves 5131 which are provided at intervals along the extending direction of the sleeve rod 513, and the thimble 5144, the fourth elastic member 5143 and the thimble base 5145 are mounted in each mounting groove 5131. The thimble 5144, the fourth elastic member 5143, and the thimble holder 5145 are installed in the same manner as described above. The plurality of mounting grooves 5131 enable the sleeve rod 513 to be adjusted in the presence of a plurality of telescoping gears relative to the sliding sleeve 512.

Referring to FIG. 11, the runner assembly 60 includes a first mounting frame 61, a second mounting frame 62, a first runner 63, a second runner 64, a third runner 65, and a fourth runner 66. The first mounting frame 61 and the second mounting frame 62 are both provided on the mounting base 10, the first mounting frame 61 and the second mounting frame 62 are respectively located on two sides of the sliding sleeve 512, the first runner 63 and the second runner 64 are both rotatably provided on the first mounting frame 61, the first runner 63 and the second runner 64 are provided perpendicularly to each other, the first runner 63 abuts against the groove bottom of the first sliding groove 5123, and the second runner 64 abuts against the groove wall of the first sliding groove 5123. The third runner 65 and the fourth runner 66 are both rotatably provided on the second mounting frame 62, the third runner 65 and the fourth runner 66 are provided perpendicular to each other, the third runner 65 abuts against the groove bottom of the second sliding groove 5124, and the fourth runner 66 abuts against the groove wall of the second sliding groove 5124. The first runner 63, the second runner 64, the third runner 65 and the fourth runner 66 cooperate together so that the sliding groove has only one direction of movement for telescopic movement relative to the mounting base 10.

In some embodiments, the runner assembly 60 further includes a fifth runner, a sixth runner, a seventh runner and an eighth runner, where the fifth runner and the sixth runner are all rotatably provided on the first mounting frame 61, the fifth runner and the sixth runner are provided perpendicular to each other, the fifth runner is in contact with the groove bottom of the first sliding groove 5123, and the sixth runner is in contact with the groove wall of the first sliding groove 5123. The seventh runner and the eighth runner are both rotatably provided on the second mounting frame 62, the seventh runner and the eighth runner are provided perpendicular to each other, the seventh runner is in contact with the groove bottom of the second sliding groove 5124, and the eighth runner is in contact with the groove wall of the second sliding groove 5124. The first runner 63, the second runner 64, the third runner 65, the fourth runner 66, the fifth runner, the sixth runner, the seventh runner, and the eighth runner cooperate so that the sliding sleeve 512 is smoother when sliding relative to the mounting base 10.

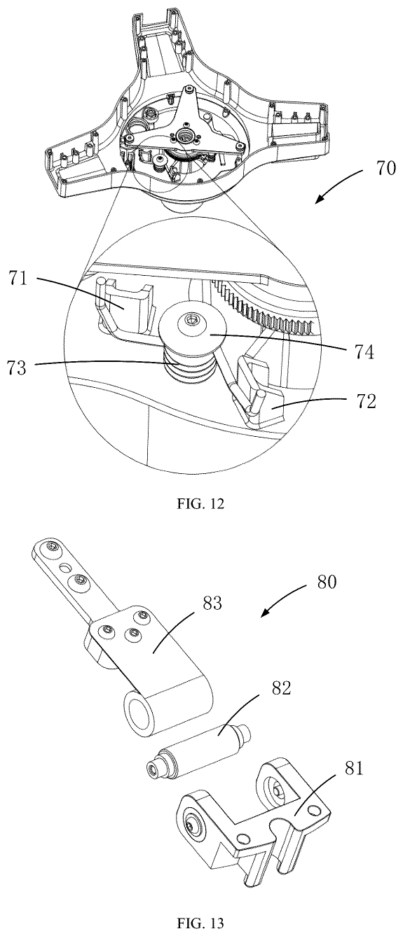

Regarding the above-mentioned limiting assembly 70, referring to FIG. 12, the limiting assembly 70 includes a first limiting protrusion 71, a second limiting protrusion 72, a limiting clastic member 73 and a limiting fixing member 74. The first limiting protrusion 71 and the second limiting protrusion 72 are fixedly provided on the mounting base 10; the limiting fixing member 74 fixes a limiting elastic member 73 on the mounting base 10; a first end of the limiting elastic member 73 abuts against the first limiting protrusion 71; the first end of the limiting clastic member 73 is used for limiting the range of motion of the rotating plate 21 in a first direction; a second end of the limiting elastic member 73 abuts against the second limiting protrusion 72; the second end of the limiting elastic member 73 is used for limiting the range of motion of the rotating plate 21 in a second direction; and the limiting elastic member 73 is used for preventing the rotating plate 21 from entering a rotation dead zone of the rotating plate 21 due to too large rotating amplitude, that is, the rotating plate 21, the connecting rod 22 and the sliding sleeve 512 are co-linear.

Regarding the second drive assembly 80 described above, referring to FIG. 13, the second drive assembly 80 includes a third mounting frame 81, a support shaft 82, and a coil spring 83. The third mounting frame 81 is fixedly provided on the mounting base 10, the support shaft 82 is provided on the third mounting frame 81, and the coil spring 83 is provided on the support shaft 82, and is connected to a first end of the sliding sleeve 512; when an external force is applied to the pull hook 52 to move the sliding sleeve 512 away from the mounting base 10, the coil spring 83 moves synchronously with the sliding sleeve 512, and at this time, the coil spring 83 is in a compressed state; when the external force is withdrawn, the coil spring 83 drives the sliding sleeve 512 to move closer to the mounting base 10 against the elastic force of deformation, and the jaw 511 clamps an object to be clamped.

In some embodiments, the second drive assembly 80 includes a tension spring, both ends of which are connected to the mounting base 10 and the clamping assembly 51, respectively.

In some embodiments, the second drive assembly 80 includes a central coil spring 83 sleeved on the rotating shaft 12, the central coil spring 83 is connected to the rotating plate 21, and the central coil spring 83 is used for driving the rotating plate 21 to rotate.

In an embodiment, referring to FIGS. 1 to 13, when the clamping device 100 needs to clamp the object to be clamped, an external force is applied to the pull hook 52, so that the clamping assembly 51 moves away from the mounting base 10; at this time, the clamping device 100 is in a state to be used for clamping, and the coil spring 83 is in a compressed state; the handle 41 is in the start position 41a; the clamping device 100 is close to the object to be clamped, and the external force is withdrawn; under the elastic force of the coil spring 83, the clamping assembly 51 moves toward the mounting base 10, and the clamping assembly 51 initially clamps the object to be clamped, then an external force is applied to the handle 41, so that the handle 41 moves in a first direction; the handle 41 drives the second connector 42, the third connector 43 and the fourth connector 44 to move, thereby pushing the rotating portion 321, the detent 322, the first connector 324 and the ratchet stop 325 to rotate synchronously; under the action of the first elastic member 323, the first connector 324 and the limiting member 326, the ratchet stop 325 always abuts against and forms a curved protrusion to slide; when the handle 41 is in a second position, the ratchet 3221 engages with the ratchet wheel 31; the handle 41 is driven then to move from the second position to the end position 41b, the rotating portion 321 drives the ratchet wheel 31 and the rotating plate 21 to rotate synchronously, and the rotating plate 21 drives the clamping assembly 51 to move towards each other via the connecting rod 22 to completely clamp the object to be clamped.

Regarding different sizes of objects to be clamped, when the clamping device 100 initially clamps the objects to be clamped, the clamping assembly 51 is at different positions, and through the cooperation of the stroke curve protrusion 211 and the ratchet component 32, the position where the ratchet 3221 engages with the ratchet wheel 31 can be controlled, so that when clamping devices 100 clamp different sizes of objects to be clamped, the retraction length of the clamping assembly 51 relative to the mounting base 10 is the same from initially clamping the objects to completely clamping the objects to be clamped.

In an embodiment, the ratchet component includes a rotating portion, a detent, a first clastic member, a first connector, a ratchet stop and a limiting member; the rotating portion is provided coaxially with the rotating assembly, and the rotating portion is rotatable relative to the rotating assembly; a first end of the detent is connected to the rotating portion, a first end of the first elastic member is connected to the mounting base, a second end of the first elastic member is connected to the first end of the detent, a second end of the detent is provided with a ratchet, and a first end of the first connector is rotatably connected to the rotating portion; a second end of the first connector is rotatably connected to a first end of the ratchet stop, the first end of the ratchet stop is provided with a first protrusion, the first protrusion abuts against the second end of the detent, the first end of the ratchet stop abuts against the stroke curve protrusion, the limiting member is fixed to the mounting base, and a second end of the ratchet stop abuts against the limiting member;

when the first drive assembly drives the rotating portion to rotate, the rotating portion rotates relative to the ratchet wheel, so that the ratchet at the second end of the detent approaches the ratchet wheel under a force of the first elastic member, the ratchet stop always abuts against the stroke curve protrusion under an action of the first connector and the limiting member, the ratchet stop rotates relative to the first connector, the first protrusion at the first end of the ratchet stop approaches the ratchet wheel, until the ratchet engages the ratchet wheel when the first drive assembly is at the second position; the first drive assembly continues to drive the rotating portion to move, and the detent drives the ratchet wheel to move so that the rotating plate drives the clamping component to move via the connecting rod.

In an embodiment, the first drive assembly includes a handle, a second connector, a third connector and a fourth connector; where a first end of the handle is rotatably connected to the mounting base, a second protrusion extends from the first end of the handle, a first end of the second connector is rotatably connected to the second protrusion, a first end of the third connector is rotatably connected to the mounting base, a second end of the third connector, a second end of the second connector and a first end of the fourth connector are rotatably connected, and a second end of the fourth connector is rotatably connected to the rotating portion;

when the handle rotates from a start position to an end position, the handle drives the second connector, the third connector and the fourth connector to move via the second protrusion to push the rotating portion to rotate; when the third connector and the fourth connector are co-linear, the first drive assembly is in a self-locked state to lock the rotating portion; and when the handle rotates from the end position to the start position, the handle drives the second connector, the third connector and the fourth connector to move via the second protrusion, so that the third connector and the fourth connector are not co-linear, the first drive assembly is in an unlocked state, and the rotating portion is movable relative to the mounting base.

In an embodiment, the fourth connector includes a compression outer cylinder, a compression rod and a second elastic member, a first end of the compression rod is rotatably connected to the second end of the third connector and the second end of the second connector, a second end of the compression rod is sleeved with the compression outer cylinder, the compression outer cylinder is rotatably connected to the rotating portion, the second elastic member is provided inside the compression outer cylinder, two ends of the second elastic member respectively abut against the compression rod and the compression outer cylinder, the compression rod is telescopically movable inside the compression outer cylinder, and the second elastic member serves to cushion the movement between the compression rod and the compression outer cylinder.

In an embodiment, the clamping component includes a jaw, a sliding sleeve, a sleeve rod and a first locking member; where the sliding sleeve is provided on the mounting base, the sliding sleeve is movable relative to the mounting base, a first end of the sliding sleeve of one of the clamping components is rotatably connected to a second end of one of the connecting rods, the sliding sleeve is provided with a telescopic groove, and the telescopic groove extends from a second end of the sliding sleeve to the first end of the sliding sleeve;
the jaw is fixed to a first end of the sleeve rod, a second end of the sleeve rod is inserted into the telescopic groove of the sliding sleeve from the second end of the sliding sleeve, and the sleeve rod is movable along the telescopic groove so that the first end of the sleeve rod moves in a direction away from the sliding sleeve or moves in a direction close to the sliding sleeve;
the first locking member is provided on the sliding sleeve and the sleeve rod, and when the first locking member is in a locked state, the sliding sleeve and the sleeve rod are fixed with each other, and when the first locking member is in an unlocked state, the sleeve rod is slideable relative to the sliding sleeve.

In an embodiment, the first locking member includes a locking base, a third clastic member, a fourth elastic member, a thimble and a button; where the sliding sleeve is provided with a first through-hole in communication with the telescopic groove, the locking base is fixed to the sliding sleeve and provided with a second through-hole, the second through-hole is in communication with the first through-hole, the button includes a pressing portion and an extending portion extending from the pressing portion, the extending portion is inserted into the second through-hole, and the extending portion is movable along the second through-hole and is inserted into the first through-hole from the second through-hole or retracted into the second through-hole from the first through-hole, and the third elastic member is located in the second through-hole; a first end of the third elastic member abuts against the pressing portion, and a second end of the third elastic member abuts against the sliding sleeve;
the sleeve rod is provided with a mounting groove, the fourth elastic member and the thimble are provided in the mounting groove, a first end of the fourth elastic member is fixed to a groove bottom of the mounting groove, and a second end of the fourth elastic member is fixed to a first end of the thimble;
when the sleeve rod slides to a position where the first through-hole corresponds to the mounting groove, the second end of the thimble protrudes from a notch of the mounting groove under a force of the fourth elastic member and is inserted into the first through-hole, so that the first locking member is in a locked state; and when the pressing portion is forced towards the sleeve rod, the extending portion is inserted into the first through-hole from the second through-hole, and the second end of the thimble is pushed out of the first through-hole, so that the first locking member is in an unlocked state.

In an embodiment, a first barrier is provided extending from a side wall of the pressing portion;

the locking base is provided with a second barrier located at an end of the second through-hole away from the first through-hole, and the second barrier is used for blocking the first barrier.

In an embodiment, the third elastic member is a spring, and is sleeved over the extending portion, and/or the second end of the thimble is provided with a transition portion.

In an embodiment, the clamping device further includes:

at least two runner assemblies, each of the at least two runner assemblies being fixed to the mounting base, a sliding sleeve of one of the clamping components being slidably provided on one of the runner assemblies.

In an embodiment, the runner assembly includes a first mounting frame, a second mounting frame, a first runner, a second runner, a third runner and a fourth runner, where the first mounting frame and the second mounting frame are fixed to the mounting base opposite to each other, the first runner and the second runner are rotatably provided on the first mounting frame, the first runner and the second runner both abut against a first side surface of the sliding sleeve, the first runner and the second runner are provided perpendicular to each other, and the third runner and the fourth runner are rotatably provided on the second mounting frame; the third runner and the fourth runner both abut against a second side surface of the sliding sleeve, and the third runner and the fourth runner are provided perpendicular to each other.

In an embodiment, a first side surface of the sliding sleeve is provided with a first sliding groove, the first runner abuts against a groove bottom of the first sliding groove, and the second runner abuts against a groove wall of the first sliding groove;

a second side surface of the sliding sleeve is provided with a second sliding groove, the third runner abuts against a groove bottom of the second sliding groove, and the fourth runner abuts against a groove wall of the second sliding groove.

In an embodiment, the clamping device further includes:

a limiting assembly, where the limiting assembly is provided on the mounting base, the limiting assembly includes a first limiting protrusion, a second limiting protrusion, a limiting clastic member and a limiting fixing member, the first limiting protrusion and the second limiting protrusion are both provided on the mounting base, the limiting fixing member fixes the limiting elastic member to the mounting base afterward, a first end of the limiting elastic member abuts against the first limiting protrusion, and a second end of the limiting elastic member abuts against the second limiting protrusion.

In an embodiment, the clamping device further includes:

a second drive assembly, where the second drive assembly includes a third mounting frame, a support shaft and a coil spring, the third mounting frame is provided in the mounting base, the support shaft is connected to the third mounting frame through the coil spring, and the coil spring is connected to one of the clamping components.

In the embodiment of the present disclosure, the technical solution that the clamping device uses a rotating assembly including a rotating plate and a connecting rod, where the connecting rod is rotatably connected to a clamping assembly and the rotating plate, respectively, and the rotating plate is provided with a stroke curve protrusion; and an engagement assembly including a ratchet wheel and a ratchet component, where the ratchet component always abuts against the stroke curve protrusion so as to adjust the engagement position of the ratchet component and the ratchet wheel. According to the described technical solution, the technical problem of a clamping device that when a first driving module rotates at the same angle, the retraction distance of the clamping assembly relative to a mounting base is inconsistent is solved, and the technical effect that when the clamping assembly is at different positions, in a process where the first driving module rotates to an end position after the ratchet component and the ratchet wheel are engaged, the retraction distance of the clamping assembly relative to the mounting base remains the same is achieved.

Advantageous effects in the embodiments of the present disclosure are: the clamping device 100 includes a mounting base 10, a clamping assembly 50, a rotating assembly 20, a first drive assembly 40 and an engagement assembly 30; the clamping assembly 50 includes at least two clamping components 51; the rotating assembly 20 includes a rotating plate 21 and at least two connecting rods 22; a first end of the connecting rod 22 is rotatably connected to the rotating plate 21; a second end of the connecting rod 22 is rotatably connected to a first end of the clamping assembly 51; the rotating plate 21 is provided with a stroke curve protrusion 211; the engagement assembly 30 includes a ratchet wheel 31 and a ratchet wheel assembly 32; the ratchet wheel 31 is coaxially and fixedly connected to the rotating plate 21; the ratchet component 32 is provided coaxially with the rotating plate 21, and the ratchet component 32 and the rotating plate 21 is movable relatively; the ratchet component 32 and the stroke curve protrusion 211 cooperate together so that the first drive assembly 40 drives the ratchet wheel 31 and the rotating plate 21 to rotate via the ratchet component 32; and the movement amplitude of the clamping assembly 50 located at any position relative to the mounting base 10 is the same. With the above-mentioned structure, the clamping device 100 may make the retraction amplitude of the clamping assembly 50 uniform when the clamping assembly 50 clamps the object to be clamped at any position, thereby making the clamping device 100 clamp the object to be clamped with uniform force.

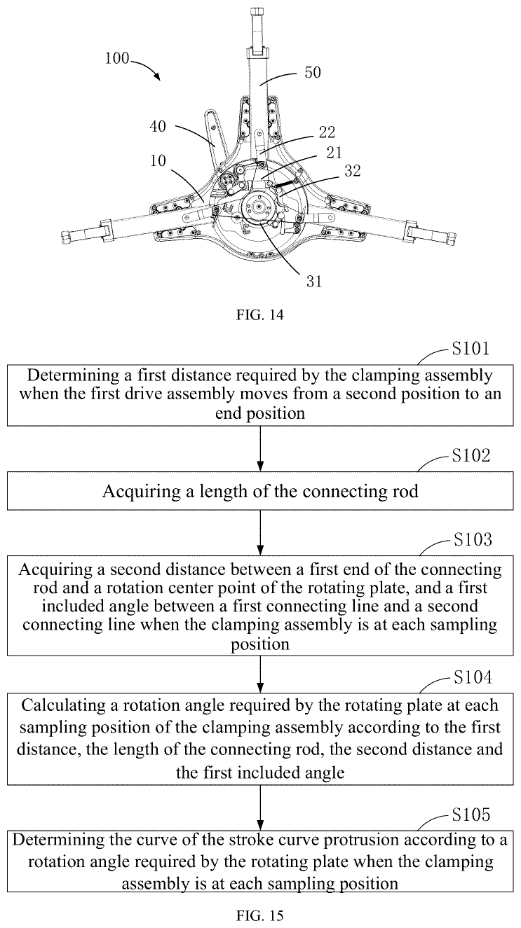

Reference is now made to FIG. 14, which is a schematic illustration of an application environment for a method for determining a curve of a stroke curve protrusion in a clamping device according to an embodiment of the present disclosure, the application environment includes: a clamping device 100 including a mounting base 10, a first drive assembly 40, a clamping assembly 50, a rotating plate 21, a connecting rod 22, a ratchet wheel 31 and a ratchet component 32.

The rotating plate 21, the ratchet wheel 31 and the ratchet component 32 are all rotatably provided on the mounting base 10; the rotating plate 21 and the ratchet wheel 31 are relatively fixed; the ratchet component 32 may rotate relative to the ratchet wheel 31 and the rotating plate 21; a first end of the connecting rod 22 is rotatably connected to the rotating plate 21; a second end of the connecting rod 22 is rotatably connected to the clamping assembly 50; the first drive assembly 40 drives the ratchet component 32 to rotate; and when the ratchet component 32 engages with the ratchet wheel 31, the ratchet component 32 rotates synchronously with the ratchet wheel 31 and the rotating plate 21 to drive the clamping assembly 50 to retract towards the mounting base 10.

FIG. 15 shows a flow chart of a method for determining a curve of a stroke curve protrusion in a clamping device according to the present disclosure, as shown in FIG. 15, including the steps of:

S101 Determining a first distance required by the clamping assembly when the first drive assembly moves from a second position to an end position.

When the first drive assembly is at the second position, the ratchet component and the ratchet wheel change from a separated state to an engaged state, and in the process of moving from the second position to the end position, the first drive assembly drives the ratchet wheel and the rotating plate to rotate synchronously, and drives the clamping assemblies to move towards each other via the connecting rod (retracting relative to the mounting base).

The first distance is a distance preset by the user, i.e. the user wants to control the retraction distance of the clamping assembly relative to the mounting base during the movement of the first drive assembly from the second position to the end position, the first distance being a constant value.

S102 Acquiring a length of the connecting rod.

S103 Acquiring a second distance between a first end of the connecting rod and a rotation center point of the rotating plate and a first included angle between a first connecting line and a second connecting line when the clamping assembly is at each sampling position, where the first connecting line is a connecting line between the second end of the connecting rod and the rotation center point of the rotating plate, and the second line is a connecting line between the first end of the connecting rod and the rotation center point of the rotating plate.

The sampling position of the clamping assembly refers to the position of the clamping assembly relative to the mounting base, and each sampling position corresponds to a position where the ratchet component and the ratchet wheel are engaged; when the sampling positions of the clamping assembly are different, the engaging positions of the ratchet component and the ratchet wheel are different; therefore, different sampling positions of the ratchet module need to be acquired to solve different engaging positions of the ratchet component and the ratchet wheel.

S104 Calculating a rotation angle required by the rotating plate when the clamping assembly is at each sampling position according to the first distance, the length of the connecting rod, the second distance and the first included angle.

The interconnection points among the connecting rod, the clamping assembly and the rotating plate may form a triangle, where the length of the connecting rod and the second distance are two sides of the triangle, and the first included angle is one included angle of the triangle, and the other side of the triangle, as well as the other two included angles, can be solved by the sine trigonometric function formula a/sin<A=b/sin<B=c/sin<C.

After retracting the clamping assembly by the first distance, a new triangle will be formed, by using the sine trigonometric function formula or cosine trigonometric function formula: a²=b²+c²−2bc cosA, b²=a²+c²−2ac cosB, c²=a²+b²−2bc cosC, the length and included angle of each side of the new triangle can be obtained, so that the required rotation angle of the rotating plate can be calculated.

S105 Determining the curve of the stroke curve protrusion according to the rotation angle required to rotate the plate when the clamping assembly is in each sampling position.

When the clamping assembly is at different sampling positions, the corresponding rotation angles are also different; after the rotation angle obtained by reversely rotating the first drive assembly from the end position, the position where the ratchet component engages with the ratchet wheel is a second position, and the curves where several second positions are located are curves where the stroke curve protrusion is located.

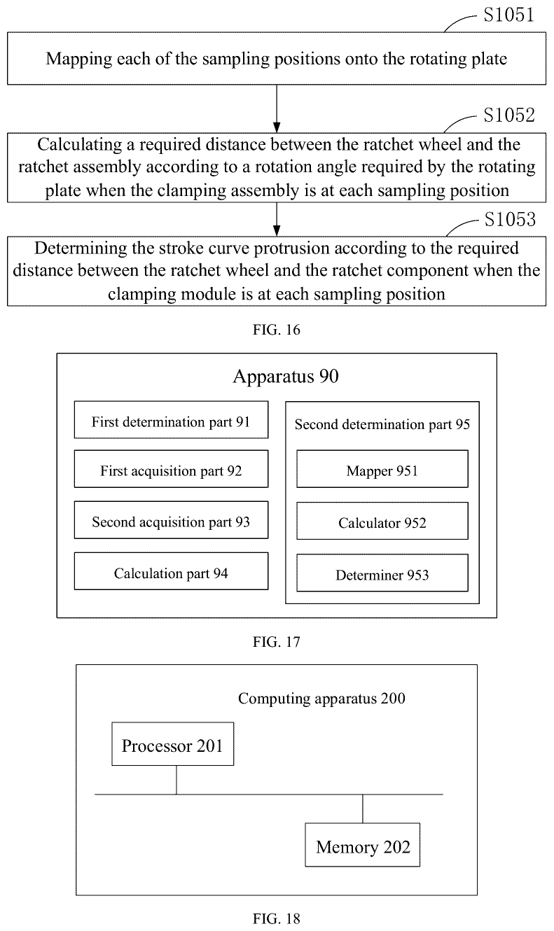

In some embodiments, referring to FIG. 16, step S105 includes:

S1051 Mapping each of the sampling positions onto the rotating plate.

S1052 Calculating a required distance between the ratchet wheel and the ratchet component according to a rotation angle required to rotate the plate when the clamping assembly is in each sampling position.

S1053 Determining the stroke curve protrusion according to the required distance between the ratchet wheel and the ratchet component when the clamping assembly is in each sampling position.

An advantageous effect of the method for determining the curve of the stroke curve protrusion of the clamping device according to the embodiments of the present disclosure is: the method

The present disclosure also provides an embodiment of an apparatus for determining the curve of the stroke curve protrusion in a clamping device. FIG. 17 shows a functional block diagram of a apparatus 90 for determining the curve of the stroke curve protrusion in a clamping device, the apparatus 90 including a first determination part 91, a first acquisition part 92, a second acquisition part 93, a calculation part 94 and a second determination part 95. A first determination part 91 is configured to determine a first distance required by the clamping assembly when the first drive assembly moves from a second position to an end position; a first acquisition part 92 is configured to acquire a length of the connecting rod; a second acquisition part 93 is configured to acquire a second distance between a first end of the connecting rod and a rotation center point of the rotating plate and a first included angle between a first connecting line and a second connecting line when the clamping assembly is at each sampling position, where the first connecting line is a connecting line between the second end of the connecting rod and the rotation center point of the rotating plate, and the second line is a connecting line between the first end of the connecting rod and the rotation center point of the rotating plate; a calculation part 94 is configured to calculate a rotation angle required by the rotating plate when the clamping assembly is at each sampling position according to the first distance, the length of the connecting rod, the second distance and the first included angle; and a second determination part 95 is configured to determine the curve of the stroke curve protrusion according to the rotation angle required to rotate the plate when the clamping assembly is in each sampling position.

The second determination part 95 includes a mapper 951, a calculator 952 and a determiner 953. A mapper 951 is configured to map each of the sampling positions onto the rotating plate; a calculator 952 is configured to calculate a required distance between the ratchet wheel and the ratchet component according to a rotation angle required to rotate the plate when the clamping assembly is in each sampling position; and a determiner 953 is configured to determine the stroke curve protrusion according to the required distance between the ratchet wheel and ratchet component when the clamping assembly is in each sampling position.

The present disclosure also provides an embodiment of a computing apparatus 200, see FIG. 18, which is a schematic diagram of an embodiment of a computing apparatus 200 of the present disclosure, the controller of the computing apparatus 200 including: at least one processor 201; and a memory 202 communicatively coupled to the at least one processor 201, one of which is exemplified in FIG. 18. The memory 202 stores instructions that are executable by the at least one processor 201 to enable the at least one processor 201 to perform a method for determining a curve of a curve of travel of a clamping device as described above referring to FIGS. 15-16 and a device for determining a curve of a curve of travel of a clamping device as described above referring to FIG. 17. The processors 201 and the memory 202 may be connected via a bus or in other ways, and via a bus connection exemplified in FIG. 18.

The memory 202 is a non-volatile or non-transitory computer-readable storage medium that may be used to store a non-volatile software program, a non-volatile computer-executable program, and modules, such as program instructions/modules corresponding to a method for determining a curve of a stroke curve protrusion of a clamping device in an embodiment of the present disclosure, such as the modules shown in FIG. 17. The processor 201 executes various functional applications of the server and data processing by running non-volatile software programs, instructions and modules stored in the memory 202, i.e., implementing a method for determining the curve of the stroke curve protrusion in the clamping device, according to the embodiments of the method described above.

The memory 202 may include a program storage area and a data storage area, where the program storage area may store an operating system and an application program required by at least one function; the data storage area may store data or the like created from the use of a device that determines the curve of the stroke curve in the clamping device. The memory 202 may include a high-speed random access memory and may also include a non-volatile memory, such as at least one magnetic disk storage apparatus, flash memory apparatus, or other non-volatile solid state storage apparatuses. In some embodiments, the memory 202 may optionally include memory remotely located relative to the processor 201, which may be connected via a network to a device for determining the curve of the stroke curve protrusion of the clamping device. Examples of such networks include, but are not limited to, the Internet, intranets, local area networks, mobile communication networks, and combinations thereof.

The one or more modules are stored in the memory 202 and, when executed by the one or more processors 201, perform a method for determining the curve on which the curve of the stroke curve of the clamping device is located in any of the method embodiments described above, e.g. perform the method steps of FIGS. 15 to 16 described above, and perform a device for determining the curve of the curve of the stroke curve in the clamping device as described above in FIG. 17.

The above-mentioned product can execute the method provided in the embodiment of the present disclosure, and has corresponding functional modules and advantageous effects for executing the method. For the technical details not described in detail in the embodiment, reference can be made to the method provided in the embodiment of the present disclosure.

Embodiments of the present disclosure also provide a non-volatile computer-readable storage medium having stored thereon computer-executable instructions that are executed by one or more processors, e.g. to perform the method steps of determining a curve on which a curve of travel of a clamping device is projected described above with respect to FIGS. 15-16, and to perform the apparatus for determining a curve on which a curve of travel of a clamping device is projected described above with respect to FIG. 17.

Embodiments of the present disclosure also provide a computer program product including a computer program stored on a non-volatile computer readable storage medium, the computer program including program instructions which, when executed by a computer, cause the computer to perform a method for determining a curve of a stroke curve protrusion in a clamping device in any of the method embodiments described above, for example, performing the method steps of FIGS. 15-16 described above, and performing a device for determining a curve of a stroke curve protrusion in a clamping device as described above in FIG. 17.

The above description is only a particular embodiment of the present disclosure, but the scope of protection of the present disclosure is not limited thereto, and changes or substitutions thereof will readily occur to a person skilled in the art within the scope of the present disclosure, and these are intended to be within the scope of protection of the present disclosure. Therefore, the scope of protection of this application should be determined by the scope of protection of the claims.

What is claimed is:

1. A clamping device, comprising:
a mounting base;
a clamping assembly comprising at least two clamping components, wherein the at least two clamping components are both provided on the mounting base, and are movable relative to the mounting base;
a rotating assembly comprising a rotating plate and at least two connecting rods, wherein the rotating plate is rotatably provided on the mounting base, first ends of the at least two connecting rods are both rotatably connected to the rotating plate, a second end of one of the at least two connecting rods is rotatably connected to one of the at least two clamping components, and the rotating plate is provided with a stroke curve protrusion;
a first drive assembly provided on the mounting base; and
an engagement assembly comprising a ratchet wheel and a ratchet component, wherein the ratchet wheel is fixed to the rotating plate, the ratchet component is rotatable relative to the rotating plate, the first drive assembly is connected to the ratchet component; when the first drive assembly is driven, the first drive assembly drives the ratchet component to move relative to the rotating assembly; when the first drive assembly is located at a first position, the ratchet wheel and the ratchet component are disengaged; when the first drive assembly is located at a second position, the ratchet wheel and the ratchet component are engaged; when the first drive assembly is located at an end position, the first drive assembly is locked; and when the first drive assembly moves from the second position to the end position, the ratchet component drives the ratchet wheel to rotate, thereby driving the rotating assembly to rotate;
wherein the stroke curve protrusion is configured to adjust, when the rotating plate rotates, a distance between the ratchet wheel and the ratchet component, so that when the clamping assembly is at different positions, the second position is different corresponding to the different positions of the clamping assembly, so that when the first drive assembly moves from the second position to the end position, the rotating plate rotates at different angles, and a moving distance of the clamping assembly at different positions relative to the mounting base remains the same.

2. The clamping device according to claim 1, wherein:
the ratchet component comprises a rotating portion, a detent, a first elastic member, a first connector, a ratchet stop and a limiting member; the rotating portion is provided coaxially with the rotating assembly, and the rotating portion is rotatable relative to the rotating assembly; a first end of the detent is connected to the rotating portion, a first end of the first elastic member is connected to the mounting base, a second end of the first elastic member is connected to the first end of the detent, a second end of the detent is provided with a ratchet, and a first end of the first connector is rotatably connected to the rotating portion; and a second end of the first connector is rotatably connected to a first end of the ratchet stop, the first end of the ratchet stop is provided with a first protrusion, the first protrusion abuts against the second end of the detent, the first end of the ratchet stop abuts against the stroke curve protrusion, the limiting member is fixed to the mounting base, and a second end of the ratchet stop abuts against the limiting member; and
when the first drive assembly drives the rotating portion to rotate, the rotating portion rotates relative to the ratchet wheel, so that the ratchet at the second end of the detent approaches the ratchet wheel under a force of the first elastic member, the ratchet stop always abuts against the stroke curve protrusion under an action of the first connector and the limiting member, the ratchet stop rotates relative to the first connector, the first protrusion at the first end of the ratchet stop approaches the ratchet wheel, until the ratchet engages the ratchet wheel when the first drive assembly is at the second position; and the first drive assembly continues to drive the rotating portion to move, and the detent drives the ratchet wheel to move so that the rotating plate drives the one of the at least two clamping components to move via the one of the at least two connecting rods.

3. The clamping device according to claim 1, wherein:
the first drive assembly comprises a handle, a second connector, a third connector and a fourth connector; wherein
a first end of the handle is rotatably connected to the mounting base, a second protrusion extends from the first end of the handle, a first end of the second connector is rotatably connected to the second protrusion, a first end of the third connector is rotatably connected to the mounting base, a second end of the third connector, a second end of the second connector and a first end of the fourth connector are rotatably connected, and a second end of the fourth connector is rotatably connected to the rotating portion; and
when the handle rotates from a start position to an end position, the handle drives the second connector, the third connector, and the fourth connector to move via the second protrusion to push the rotating portion to rotate; when the third connector and the fourth connector are co-linear, the first drive assembly is in a self-locked state to lock the rotating portion; and when the handle rotates from the end position to the start position, the handle drives the second connector, the third connector, and the fourth connector to move via the second protrusion, so that the third connector and the fourth connector are not co-linear, the first drive assembly is in an unlocked state, and the rotating portion is movable relative to the mounting base.

4. The clamping device according to claim 3, wherein:
the fourth connector comprises a compression outer cylinder, a compression rod, and a second elastic member, a first end of the compression rod is rotatably connected to the second end of the third connector and the second end of the second connector, a second end of the compression rod is sleeved with the compression outer cylinder, the compression outer cylinder is rotatably connected to the rotating portion, the second elastic member is provided inside the compression outer cylinder, two ends of the second elastic member respectively abut against the compression rod and the compression outer cylinder, the compression rod is telescopically movable inside the compression outer cylinder, and the second elastic member serves to cushion the movement between the compression rod and the compression outer cylinder.

5. The clamping device according to claim 1, wherein:
the one of the at least two clamping components comprises a jaw, a sliding sleeve, a sleeve rod, and a first locking member; wherein
the sliding sleeve is provided on the mounting base, the sliding sleeve is movable relative to the mounting base, a first end of the sliding sleeve of the one of the at least two clamping components is rotatably connected to a second end of the one of the at least two connecting rods, the sliding sleeve is provided with a telescopic groove, and the telescopic groove extends from a second end of the sliding sleeve to the first end of the sliding sleeve;
the jaw is fixed to a first end of the sleeve rod, a second end of the sleeve rod is inserted into the telescopic groove of the sliding sleeve from the second end of the sliding sleeve, and the sleeve rod is movable along the telescopic groove so that the first end of the sleeve rod moves in a direction away from the sliding sleeve or moves in a direction close to the sliding sleeve; and
the first locking member is provided on the sliding sleeve and the sleeve rod, and when the first locking member is in a locked state, the sliding sleeve and the sleeve rod are fixed with each other, and when the first locking member is in an unlocked state, the sleeve rod is slidable relative to the sliding sleeve.

6. The clamping device according to claim 5, wherein:
the first locking member comprises a locking base, a third elastic member, a fourth elastic member, a thimble, and a button; wherein
the sliding sleeve is provided with a first through-hole in communication with the telescopic groove, the locking base is fixed to the sliding sleeve and provided with a second through-hole, the second through-hole is in communication with the first through-hole, the button comprises a pressing portion and an extending portion extending from the pressing portion, the extending portion is inserted into the second through-hole, and the extending portion is movable along the second through-hole and is inserted into the first through-hole from the second through-hole or retracted into the second through-hole from the first through-hole, and the third elastic member is located in the second through-hole; a first end of the third elastic member abuts against the pressing portion, and a second end of the third elastic member abuts against the sliding sleeve;
the sleeve rod is provided with a mounting groove, the fourth elastic member and the thimble are provided in the mounting groove, a first end of the fourth elastic member is fixed to a groove bottom of the mounting groove, and a second end of the fourth elastic member is fixed to a first end of the thimble; and
when the sleeve rod slides to a position where the first through-hole corresponds to the mounting groove, the second end of the thimble protrudes from a notch of the mounting groove under a force of the fourth elastic member and is inserted into the first through-hole, so that the first locking member is in a locked state; and when the pressing portion is forced towards the sleeve rod, the extending portion is inserted into the first through-hole from the second through-hole, and the second end of the thimble is pushed out of the first through-hole, so that the first locking member is in an unlocked state.

7. The clamping device according to claim 6, wherein:
a first barrier is provided extending from a side wall of the pressing portion; and
the locking base is provided with a second barrier located at an end of the second through-hole away from the first through-hole, and the second barrier is used for blocking the first barrier.

8. The clamping device according to claim 6, wherein:
the third elastic member is a spring, and is sleeved over the extending portion, and/or the second end of the thimble is provided with a transition portion.

9. The clamping device according to claim 1, further comprising:
at least two runner assemblies, each of the at least two runner assemblies being fixed to the mounting base, a sliding sleeve of the one of the at least two clamping components being slidably provided on one of the at least two runner assemblies.

10. The clamping device according to claim 9, wherein:
the one of the at least two runner assemblies comprises a first mounting frame, a second mounting frame, a first runner, a second runner, a third runner, and a fourth runner, wherein the first mounting frame and the second mounting frame are fixed to the mounting base opposite to each other, the first runner and the second runner are rotatably provided on the first mounting frame, the first runner and the second runner both abut against a first side surface of the sliding sleeve, the first runner and the second runner are provided perpendicular to each other, and the third runner and the fourth runner are rotatably provided on the second mounting frame; the third runner and the fourth runner both abut against a second side surface of the sliding sleeve, and the third runner and the fourth runner are provided perpendicular to each other.

11. The clamping device according to claim 10, wherein:
the first side surface of the sliding sleeve is provided with a first sliding groove, the first runner abuts against a groove bottom of the first sliding groove, and the second runner abuts against a groove wall of the first sliding groove; and
the second side surface of the sliding sleeve is provided with a second sliding groove, the third runner abuts against a groove bottom of the second sliding groove, and the fourth runner abuts against a groove wall of the second sliding groove.

12. The clamping device according to claim 1, further comprising:
a limiting assembly, wherein the limiting assembly is provided on the mounting base, the limiting assembly comprises a first limiting protrusion, a second limiting protrusion, a limiting elastic member, and a limiting fixing member, the first limiting protrusion and the second limiting protrusion are both provided on the mounting base, the limiting fixing member fixes the limiting elastic member to the mounting base afterward, a first end of the limiting elastic member abuts against the first limiting protrusion, and a second end of the limiting elastic member abuts against the second limiting protrusion.

13. The clamping device according to claim 1, further comprising:
a second drive assembly, wherein the second drive assembly comprises a third mounting frame, a support shaft, and a coil spring, the third mounting frame is provided in the mounting base, the support shaft is connected to the third mounting frame through the coil spring, and the coil spring is connected to the one of the at least two clamping components.

14. A method for determining a curve of a stroke curve protrusion in the clamping device according to claim 1, the method comprising:
determining a first distance required by the clamping assembly when the first drive assembly moves from a second position to an end position;
acquiring a length of the one of the at least two connecting rods;
acquiring a second distance between a first end of the one of the at least two connecting rods and a rotation center point of the rotating plate, and a first included angle between a first connecting line and a second connecting line when the clamping assembly is at each sampling position, wherein the first connecting line is a connecting line between the second end of the one of the at least two connecting rods and the rotation center point of the rotating plate, and the second line is a connecting line between the first end of the one of the at least two connecting rods and the rotation center point of the rotating plate;
calculating a rotation angle required by the rotating plate when the clamping assembly is at each sampling position according to the first distance, the length of the one of the at least two connecting rods, the second distance and the first included angle; and
determining the curve of the stroke curve protrusion according to the rotation angle required to rotate the plate when the clamping assembly is at each sampling position.

15. The method according to claim 14, wherein determining the curve of the stroke curve protrusion according to the rotation angle required to rotate the plate when the clamping assembly is at each sampling position further comprises:
mapping each of the sampling positions onto the rotating plate;
calculating a distance required between the ratchet wheel and the ratchet component according to the rotation angle required to rotate the plate when the clamping assembly is at each sampling position; and
determining the stroke curve protrusion according to the distance required between the ratchet wheel and the ratchet component when the clamping assembly is at each sampling position.

16. A computing apparatus, comprising:
a controller, comprising: at least one processor and a memory communicatively connected to the at least one processor;
wherein the memory stores instructions executable by the at least one processor, the instructions being executed by the at least one processor to cause the at least one processor to perform acts comprising:
determining a first distance required by a clamping assembly when a first drive assembly moves from a second position to an end position;
acquiring a length of a connecting rod;
acquiring a second distance between a first end of the connecting rod and a rotation center point of a rotating plate, and a first included angle between a first connecting line and a second connecting line when the clamping assembly is at each sampling position, wherein the first connecting line is a connecting line between a second end of the connecting rod and the rotation center point of the rotating plate, and the second line is a connecting line between the first end of the connecting rod and the rotation center point of the rotating plate;
calculating a rotation angle required by the rotating plate when the clamping assembly is at each sampling position according to the first distance, the length of the connecting rod, the second distance and the first included angle; and
determining a curve of a stroke curve protrusion according to the rotation angle required to rotate the plate when the clamping assembly is at each sampling position.
